(19) United States
(12) Patent Application Publication
(10) Pub. No.: US 2024/0258816 A1
(43) Pub. Date: Aug. 1, 2024

(54) CURRENT SHARING IN PARALLEL BATTERY SYSTEM

(71) Applicant: Green Cubes Technology, LLC, Kokomo, IN (US)

(72) Inventor: Nicola Cinagrossi, Uster (CH)

(73) Assignee: Green Cubes Technology, LLC, Kokomo, IN (US)

(21) Appl. No.: 18/565,761

(22) PCT Filed: Jun. 1, 2021
(86) PCT No.: PCT/US2021/035301

§ 371 Date: Nov. 30, 2023

(51) Int. Cl. H02J 7/00; H01M 10/42; H01M 10/44; H01M 10/48; H01M 50/258

(52) U.S. Cl. CPC H02J 7/00712; H01M 10/441; H01M 10/482; H01M 50/258; H01M 2010/4271

(57) ABSTRACT

Disclosed herein are battery packs, modular battery systems, and improved methods of impedance balancing for current sharing among parallel battery packs. Each parallel battery pack's impedance can be controlled by adding a controlled impedance and a control circuit. The controlled impedance is an impedance that can be varied, and/or controlled, using different impedance values. The control circuit communicates with other battery packs to determine impedance values (or an average impedance) for the other battery packs in a battery system. The controlled impedance can then increase the total impedance for the more highly used batteries (i.e., batteries delivering more current) to balance it with other less used batteries. By balancing impedance between parallel battery packs in a modular battery system, the current will be equally shared between the battery packs, thus ensuring all the battery packs in parallel have similar usage and similar operating lifetimes.

### BACKGROUND

Battery technology has become widely used in a variety of applications, from small electronic appliances to electric cars and data centers. Battery manufacturers have started designing batteries having modular battery packs that can be connected in either parallel, or in series, to produce the desired voltage and capacity. However, one remaining issue still challenging battery manufacturers in these modular battery pack designs is that current sharing between the battery packs provides a small difference in impedance, but a large different in current sharing. While the difference in impedance might be considered small, the effect on current sharing will be significant. For example, if there are 3 battery packs in parallel where the total impedance for battery pack 1 is 5 mohm, for battery pack 2 is 10 mohm, and for battery pack 3 is 3 mohm; when a 100 A current is needed from the parallel battery packs, the individual currents will be 31.6 A for battery pack 1, 15.8 A for battery pack 2, and 52.6 A for battery pack 3. Thus, any small difference in impedance will cause large differences in current sharing.

Because of this discrepancy between impedance and current sharing, one of the battery packs within a battery system will eventually be more stressed than the others, which will directly affect the lifetime of that battery pack, and/or will lead to triggering of overcurrent protection for that particular battery pack. Most battery pack users experience an undesirably shortened battery pack lifetime (i.e., end of life EOL) due to this unbalanced resistance.

To avoid triggering overcurrent protection, or undesirable EOL problems, battery pack users have been trying to balance the current between the battery packs within a battery system by balancing the output battery cables during installation to minimize the impedance effect. However, the result provided by attempting to balance the output battery cables is not only time consuming, but also unpredictable, as the input impedance can vary due to several different factors (both external and internal) such as internal cables/connections resistance, cells temperature, and cells resistance, etc.

Having a controllable impedance inside each battery pack can minimize the impedance unbalance effect as each battery pack can calculate the average current, compare it to the current of each of the other battery packs, and set the controllable impedance of each battery pack to a proper value to achieve balanced battery pack current sharing. It would thus be desirable to have an improved method of impedance balancing designed into each battery pack in a modular battery system. Disclosed herein are improved battery packs, systems, and methods of impedance balancing of parallel battery modules within a battery pack in order to balance the impedance of the parallel battery modules in a battery pack without adversely affecting the current sharing.

### BRIEF SUMMARY OF THE INVENTION

The present disclosure includes disclosure of a system for balancing current by controlling impedance in parallel battery packs, each battery pack comprising: a controlled impedance operably coupled to an internal impedance and an external impedance, wherein the controlled impedance can be adjusted to control current sharing with at least one other battery pack; and a control circuit operably coupled to the controlled impedance, wherein the control circuit is configured to exchange data with at least one other battery pack; and wherein the control circuit determines an average current needed from each battery pack in the system, or determines a highest or lowest current provided by any of the battery packs in the system, and compares that current to an actual current drawn or supplied to a particular battery pack, and then adjusts current of the particular battery pack by adjusting the controlled impedance.

The present disclosure also includes disclosure of a system, wherein adjusting the controlled impedance comprises adjusting current of the particular battery pack to be closer to the average current needed.

The present disclosure also includes disclosure of a system, wherein adjusting the controlled impedance comprises balancing impedance among parallel battery packs so current is equally shared among parallel battery packs.

The present disclosure also includes disclosure of a system, wherein the controlled impedance can balance total resistance for each battery pack in a battery system by balancing internal impedance, external impedance, and controlled impedance.

The present disclosure also includes disclosure of a system, wherein the internal impedance comprises any one or more of cell resistance, cell temperature, cell age, connection and/or cable impedances, busbars, and protection switches.

The present disclosure also includes disclosure of a system, further comprising a communication bus operably coupled to each of the battery packs in the system, for exchanging impedance data with each of the battery packs in the system.

The present disclosure also includes disclosure of a system, wherein the communication bus is digital and is a communication area network (CAN) bus system.

The present disclosure also includes disclosure of a system, wherein the communication bus is analogue.

The present disclosure also includes disclosure of a system, wherein the controlled impedance used to balance current between the parallel battery packs is controlled using a switching regulator to introduce a voltage drop between battery cells of each of the battery packs and each battery pack's input/output (I/O) power connector.

The present disclosure also includes disclosure of a system, wherein the battery system is modular and comprises a plurality of battery packs, wherein more than one battery pack can be added in parallel to expand the battery system.

The present disclosure also includes disclosure of a system, wherein the battery system is modular and comprise a plurality of battery packs, wherein the plurality of battery packs are swappable and removable for easy replacement.

The present disclosure also includes disclosure of a system, further comprising a dead band and/or an impedance clamp.

The present disclosure also includes disclosure of a method for current sharing among parallel battery packs in a battery system, comprising: providing the system of claim 1, the system having a plurality of battery packs; and connecting the plurality of battery packs in parallel.

The present disclosure also includes disclosure of a method, further comprising: determining an average current needed from each of the plurality of battery packs in the system, or determining a highest or lowest current from at least one of the plurality of battery packs in the system, using the control circuit.

The present disclosure also includes disclosure of a method, further comprising: comparing the average current needed from each of the plurality of battery packs, or comparing the highest or lowest current from at least one of the plurality of battery packs in the system, with an actual current drawn or supplied to each of the plurality of battery packs.

The present disclosure also includes disclosure of a method, further comprising: adjusting impedance of a particular battery pack, using the controlled impedance and the control circuit, to control current sharing between the particular battery pack and each of the plurality of battery packs in the system.

The present disclosure also includes disclosure of a method, wherein adjusting a particular battery pack's impedance comprises adjusting the impedance to be closer to the average current needed.

The present disclosure also includes disclosure of a battery pack having impedance balancing control, comprising: a controlled impedance adjustable to control impedance and/or current sharing with other battery packs; and a control circuit operably coupled to the controlled impedance, wherein the control circuit is configured to exchange data with other battery packs; and wherein if current of the battery pack is different from a predetermined current value, then the control circuit changes the controlled impedance to change current of the battery pack, to balance current between the battery pack and other battery packs.

The present disclosure also includes disclosure of a battery pack, wherein if current of the battery pack is higher than a predetermined current value, then the control circuit increases the controlled impedance to reduce current of the battery pack, to balance current between the battery pack and other battery packs.

The present disclosure also includes disclosure of a battery pack, wherein if current of the battery pack is lower than a predetermined current value, then the control circuit decreases the controlled impedance to increase current of the battery pack, to balance current between the battery pack and other battery packs.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of the present disclosure taken in conjunction with the accompanying drawings, wherein:

FIG. 1 illustrates a graph of battery characteristic using controlled impedance to balance battery current;

FIG. 2 illustrates a schematic diagram of an exemplary battery pack;

FIG. 3 illustrates a schematic diagram of exemplary battery packs connected in parallel with a load and/or a battery charger;

FIG. 4 illustrates an exemplary control system to control impedance of parallel battery packs; and

FIG. 5 illustrates a front view of an exemplary battery system having back-up battery packs connected in parallel with a communication bus connection and with a load and/or a battery charger.

As such, an overview of the features, functions and/or configurations of the components depicted in the figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

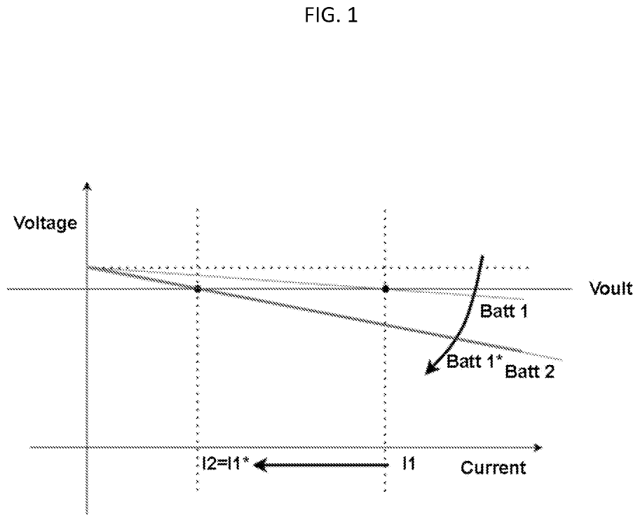

Disclosed herein are battery packs, modular battery systems, and improved methods of impedance balancing for equal current sharing among parallel battery packs. A system for balancing current by controlling impedance in parallel battery packs is disclosed. The current may be balanced by adding a controlled impedance inside each parallel battery pack in a modular battery system. The controlled impedance may increase the total impedance for the more highly used batteries (i.e., batteries delivering more current) to balance it with other less used batteries as shown in FIG. 1. By balancing impedance between parallel battery packs in a modular battery system, the current will be equally shared between the battery packs, thus ensuring all the battery packs in parallel will have similar usage and a similar operating lifetime.

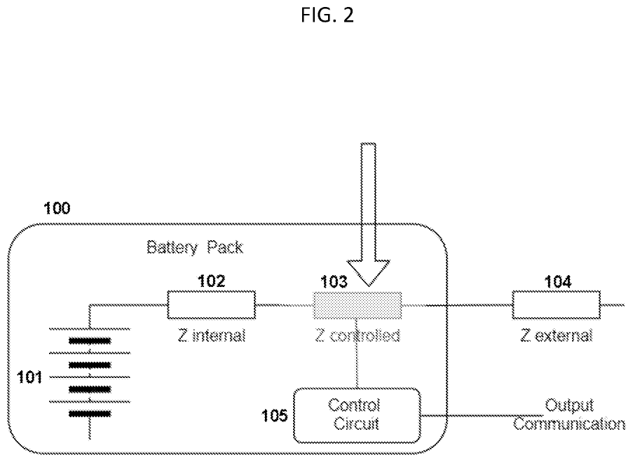

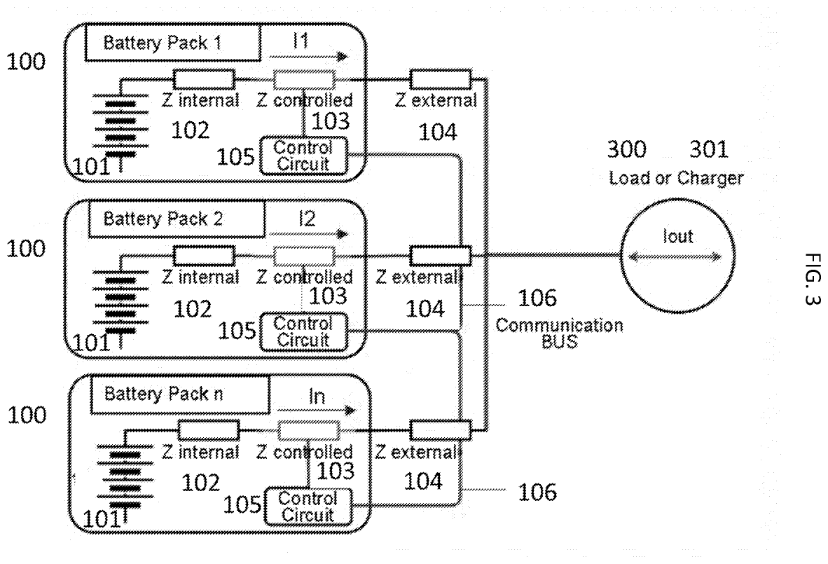

As shown in FIGS. 2 and 3, an exemplary battery pack 100 may include battery cells 101, internal impedance 102, controlled impedance 103, external impedance 104, and a control circuit 105. The controlled impedance 103 is an impedance that can be varied, and/or controlled, using different impedance values. The control circuit 105 may be operably coupled to the controlled impedance 103, in order to physically implement, set, and/or control the impedance within the battery pack 100. The internal impedance 102 may be a function of battery temperature, age, cell connection busbars, internal cables, connectors, etc. The external impedance 104 may be a function of the battery pack's external cables, connectors, etc.

The control circuit 105 in each battery pack 100 is in operable communication with other battery packs 100, to exchange (i.e., both send and receive) impedance, current, and other operating data. The controlled impedance is in operable communication with the control circuit 105 and can be controlled to set and/or adjust the impedance of the battery pack 100 to an appropriate impedance value in order to balance the parallel battery packs 100 in a battery system. In this embodiment, the battery packs 100 may check the current value of each battery pack 100 in a system, through a communication bus such as CAN bus, to calculate the appropriate impedance value to balance the current sharing among the battery packs 100 in a battery system. Said another way, if the battery pack's 100 current is different from a predetermined current value, or different from the other battery pack's 100, then the control circuit 105 may change the controlled impedance 103 to change the battery pack's 100 current, to balance current between the battery pack 100 and other battery packs 100 in the battery system.

As shown in FIG. 3, the battery packs 100 may be connected in parallel to supply power (discharge) to the load 300 or to receive the power (charge) from a battery charger 301. The battery packs 100 may share among them the value of their own currents through a communication bus 106. The communication bus may be analogue or digital, such as CAN. The communication bus 106 may also be connected to the control circuit 105 of each battery pack, as shown in FIG. 3, for exchange of data.

In one embodiment shown in FIGS. 3 & 4, the control circuit 105 for each battery pack 100 may determine the average current 201 of the paralleled battery packs 100, and/or may determine the highest or lowest current of the paralleled battery packs 100, and may then compare it with an individual battery pack's 100 actual current 202 needed or drawn. In one embodiment, the average current 201 of each battery pack 100 is determined and/or calculated and then compared to an actual current 202 needed or drawn (by a particular battery pack 100). The control circuit 105 may then adjust the current (of the particular battery pack 100) to be closer to the average current 201 needed. For example, if the individual/particular battery pack's 100 current 202 is higher than the average current 201, then the control circuit 105 may increase the controlled impedance 103 (to be closer to the average current) or reduce the individual/particular battery pack's 100 current, thus balancing the current between the parallel battery packs 100. Conversely, if the individual/particular battery pack's current 202 is lower than the average current 201, then the control circuit may decrease the controlled impedance 103 to increase the individual battery pack's 100 current, thus balancing the current between the parallel battery packs 100. In some embodiments, an average current 201 may be determined or calculated using each of the battery packs 100 in the system and/or some number of battery packs 100 in the system. In other embodiments, a predetermined and/or preprogrammed threshold current value may be used for comparison to determine if an individual battery pack's current and/or impedance needs adjusted.

In other embodiments, this control circuit 105 and/or controlled impedance 103 may be in operable communication with, and/or may also comprise a battery management system (BMS). The BMS and/or control circuit 105 may be in operable communication with, and/or may include, but are not limited to, a general processor, a central processing unit, logical CPUs/arrays, a microcontroller, an application specific integrated circuit (ASIC), a digital signal processor, a field programmable gate array (FPGA), and/or a digital circuit, analog circuit, or some combination thereof. In some embodiments, the control circuit 105 and/or BMS may be one or more devices operable to execute logic. The logic may include computer executable instructions or computer code stored in memory that when executed by a processor and/or the control circuit 105, causes the battery packs 100 and/or the BMS to perform the operations described herein above.

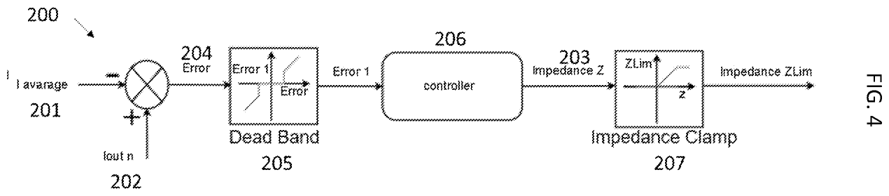

FIG. 4 illustrates a flowchart of an exemplary impedance balancing method 200. In one embodiment, the impedance balancing or impedance controlling method 200 may operate using the control circuit 105, shown generally as the controller 206 in FIG. 4. In some embodiments, the controller 206 is a proportional-integrative controller 206 implemented as firmware in the uP. The control circuit 105 may contain the hardware (uP) such as for running the control algorithm, through a digital implementation. The control circuit 105 of each battery pack 100 may determine and/or compare the particular battery pack's 100 current 202 (Iout n) with an average current 201 (I average) of the other parallel battery packs 100 and/or may determine and/or compare the particular battery pack's current 202 (Iout n) with a highest or lowest current of the any of the other battery packs 100 in parallel.

In some embodiments, each battery pack's control circuit 105 may know the current from the other parallel battery packs 100, to then calculate the average (I1+I2+ . . . In)/n current of the parallel battery packs 100. In some embodiments, delivering the average current to a particular/individual battery pack 100 may remove any current unbalancing among the other parallel battery packs 100. If the current in the particular battery pack 202 is higher than the average current 202, then the controller 206 may increase the impedance Z 203 to minimize the error 204 (Error). The controller 206 may also utilize a dead band block 205 to avoid oscillation. Additionally, the controller 206 may be limiting the required impedance to an absolute maximum (such as via impedance clamp 207) to limit voltage drop across the controlled impedance 103.

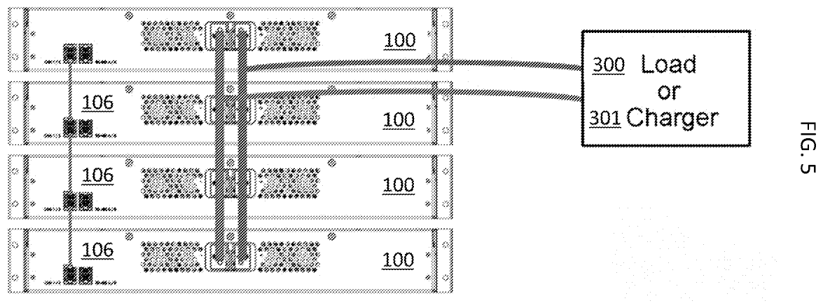

FIG. 5 illustrates an exemplary battery system having several battery packs 100 connected in parallel. The battery packs 100 may also connected to an input/output load 300 and/or to a battery charger 301. Additionally, the parallel battery packs 100 may be connected together, or in operable communication, via a communication bus 106, to exchange battery current and/or impedance information. The communication bus 106 allows communications to and from each battery pack 100 in a system. In some embodiments, the communication bus 106 may be analogue, and in some embodiments may be digital, such as a CAN bus.

In one embodiment, the controlled impedance 103 may be controlled and/or adjusted by using a semiconductor, such as a transistor operating in linear mode, to introduce a voltage drop between a battery system and the I/O power connector. This voltage drop may simulate a controlled impedance, which introduces a voltage drop if crossed by electrical current.

In another embodiment, the controlled impedance may be controlled and/or adjusted by using a switching regulator. This switching regulator may also introduces a voltage drop between a battery system and the I/O power connector. This voltage drop may simulate a controlled impedance, which introduces a voltage drop if crossed by electrical current. In this approach, the switching regulator may dissipate only the power related to its non-ideal conversion efficiency.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A system for balancing current by controlling impedance in parallel battery packs, each battery pack comprising:
a controlled impedance operably coupled to an internal impedance and an external impedance, wherein the controlled impedance can be adjusted to control current sharing with at least one other battery pack; and
a control circuit operably coupled to the controlled impedance, wherein the control circuit is configured to exchange data with at least one other battery pack; and
wherein the control circuit determines an average current needed from each battery pack in the system, or determines a highest or lowest current provided by any of the battery packs in the system, and compares that current to an actual current drawn or supplied to a particular battery pack, and then adjusts the current of the particular battery pack by adjusting the controlled impedance.

2. The system of claim 1, wherein adjusting the controlled impedance comprises adjusting current of the particular battery pack to be closer to the average current needed.

3. The system of claim 1, wherein adjusting the controlled impedance comprises balancing impedance among parallel battery packs so current is equally shared among parallel battery packs.

4. The system of claim 1, wherein the controlled impedance can balance total resistance for each battery pack in a battery system by balancing internal impedance, external impedance, and controlled impedance.

5. The system of claim 1, wherein the internal impedance comprises any one or more of cell resistance, cell temperature, cell age, connection and/or cable impedances, busbars, and protection switches.

6. The system of claim 1, further comprising a communication bus operably coupled to each of the battery packs in the system, for exchanging impedance data with each of the battery packs in the system.

7. The system of claim 6, wherein the communication bus is digital and is a controller area network (CAN) bus system.

8. The system of claim 6, wherein the communication bus is analogue.

9. The system of claim 1, wherein the controlled impedance used to balance current between the parallel battery packs is controlled using a switching regulator to introduce a voltage drop between battery cells of each input/output (I/O) power connector of each of the battery packs.

10. The system of claim 1, wherein the battery system is modular and comprises a plurality of battery packs, wherein more than one battery pack can be added in parallel to expand the battery system.

11. The system of claim 1, wherein the battery system is modular and comprise a plurality of battery packs, wherein the plurality of battery packs are swappable and removable for easy replacement.

12. The system of claim 1, further comprising a dead band and/or an impedance clamp.

13. A method for current sharing among parallel battery packs in a battery system, comprising:
providing the system of claim 1, the system having a plurality of battery packs; and
connecting the plurality of battery packs in parallel.

14. The method of claim 13, further comprising:
determining an average current needed from each of the plurality of battery packs in the system, or determining a highest or lowest current from at least one of the plurality of battery packs in the system, using the control circuit.

15. The method of claim 14, further comprising:
comparing the average current needed from each of the plurality of battery packs, or comparing the highest or lowest current from at least one of the plurality of battery packs in the system, with an actual current drawn or supplied to each of the plurality of battery packs.

16. The method of claim 15, further comprising:
adjusting impedance of the particular battery pack, using the controlled impedance and the control circuit, to control current sharing between the particular battery pack and each of the plurality of battery packs in the system.

17. The method of claim 16, wherein adjusting impedance of the particular battery pack comprises adjusting the impedance to be closer to the average current needed.

18. A battery pack having impedance balancing control, comprising:
a controlled impedance adjustable to control impedance and/or current sharing with other battery packs; and
a control circuit operably coupled to the controlled impedance, wherein the control circuit is configured to exchange data with other battery packs; and
wherein if current of the battery pack is different from a predetermined current, then the control circuit changes the controlled impedance to change current of the battery pack, to balance current between the battery pack and other battery packs.

19. The battery pack of claim 18, wherein if current of the battery pack is higher than a predetermined current value, then the control circuit increases the controlled impedance to reduce current to the battery pack, to balance current between the battery pack and other battery packs.

20. The battery pack of claim 18, wherein if current of the battery pack is lower than a predetermined current value, then the control circuit decreases the controlled impedance to increase current to the battery pack, to balance current between the battery pack and other battery packs.
